(19) United States
(12) Patent Application Publication
(10) Pub. No.: US 2015/0313092 A1
(43) Pub. Date: Nov. 5, 2015

(54) METHOD AND ILLUMINATION SYSTEM FOR PLANT RECOVERY FROM STRESS

(71) Applicant: HELIOSPECTRA AB, Göteborg (SE)

(72) Inventors: Tessa POCOCK, SUNDSVALL (SE); Torsten WIK, GOTEBORG (SE); Anna-Maria CARSTENSEN, JORLANDA (SE)

(73) Assignee: HELIOSPECTRA AB, Goteborg (SE)

(21) Appl. No.: 14/651,723

(22) PCT Filed: Dec. 12, 2013
(86) PCT No.: PCT/SE2013/051504

§ 371 Date: Jun. 12, 2015

(30) Foreign Application Priority Data
Dec. 20, 2012 (SE) 1251481-6

(51) Int. Cl. A01G 7/04; H05B 33/08; A01G 1/00

(52) U.S. Cl. CPC A01G 7/045; A01G 1/001; H05B 33/0842

(57) ABSTRACT

The invention relates to a method for artificial illumination of a plant, the method comprising the steps of: controlling an illumination system to illuminate the plant, the emitted light having a first spectral distribution and a first intensity level, the first spectral distribution and the first intensity level selected for optimizing growth of the plant; detecting, using a sensor, the presence of stress in the plant; if stress is detected, controlling the illumination system to illuminate the plant with light having a second spectral distribution and a second intensity level, the second intensity level being lower than the first intensity level. The invention also relates to an illumination system for artificial illumination of a plant according to the method above.

### TECHNICAL FIELD

The present invention relates to a method for plant recovery from stress, induced for example by light, temperature, nutrient, water, pests and diseases, using an artificial illumination system in a photosynthetic environment, such as for example using an illumination system arranged in a greenhouse, a walk-in chamber or a growth cabinet. The invention also relates to a corresponding illumination system, use of the illumination system and a computer program product.

### BACKGROUND OF THE INVENTION

Artificial and supplemental lighting in e.g. a greenhouse typically involves use of an illumination system for stimulating plant growth, the illumination system comprising a plurality of high power light sources. Different types of light sources, having different light spectra and providing different effects on growth stimulation, may be included, such as light sources based on metal halide (MH) or high intensity discharge (HID) which includes high pressure sodium (HPS) or fluorescent or incandescent bulbs.

Recently, much progress has been made in increasing the brightness of light emitting diodes (LEDs). As a result, LEDs have become sufficiently bright and inexpensive to serve also for artificial lighting in e.g. a greenhouse environment, additionally providing the possibility of emitting light with adjustable color (light spectrum). By mixing differently colored LEDs any number of colors can be generated. An adjustable color lighting system typically comprises a number of primary colors, for one example the three primaries red, green and blue. The color of the generated light is determined by the LEDs that are used, as well as by the mixing ratios. By using LEDs it is possible to decrease the energy consumption, a requirement that is well in line with the current environmental trend. Additionally, using LED based illumination system minimizes the amount of light source generated heat which is specifically suitable in an environment where temperature control is desirable.

As is well known for the persons skilled in the art, light provides the energy for photosynthesis but, it can be damaging when the rate of light absorption exceeds the rate of energy use within the chloroplasts. Photoinhibition is the light-dependent decrease in photosynthetic efficiency and has long been correlated to the decrease in maximum photosystem II (PSII) photochemical efficiency (F_{V}/F_{M}) (Kok 1956, Long et al. 1994). Originally, it was thought that photoinhibition was a high light phenomenon but it has been shown that it occurs under low light intensities and is thus an inevitable event in all natural habitats. Indeed, photoinhibition can result in irreversible stress-induced damage but it can also reflect reversible photo-protective mechanisms. The recovery kinetics of photosynthesis are biphasic with a fast phase (20-60 min) that is independent of protein synthesis and a slower phase (hours) that is dependent on PSII re-activation and the D1 repair cycle (Hurry and Huner 1992, Leitsch et al. 1994). Recovery of photosynthesis from high light stress is typically performed under ‘white light’ (High Pressure Sodium (HPS) or fluorescent tubes) and has been found to be optimal at low light (20-50 μmol quanta m⁻² s⁻¹) (Polle and Melis 1999). It was concluded that light was necessary for the full recovery from photoinhibition as it provides the required energy through photosynthesis.

In nature, plants are exposed to different and changing light qualities. For instance, within and under plant canopies plant leaves are acclimated to a dim far-red rich environment (700-800 nm) and during a sunfleck can be quickly exposed to full spectrum saturating light. On a diurnal scale, the spectrum switches from blue enriched morning light to equal spectral ratios at mid-day to red-enriched evening light (Orust, Sweden; latitude 58° 13′, December 2009) (Pocock, unpub. data). Furthermore, light quality differs between physical layers within the leaf and this has been correlated to differing photosynthetic capacities along leaf light quality gradients (Sun et al. 1998, Terashima et al. 2009). Photomorphogenesis, the spectra-dependent changes in plant morphology and development, is the most widely studied light quality phenomenon in plants (Lin and Todo 2005, Thomas 2006, Chory 2010, Quail 2010). However, it has been shown that photosynthesis is affected by light quality with most of the research investigating the effect of the red and blue regions of the spectrum. Photosynthetic properties that are adjusted by red or blue light include chlorophyll biogenesis, chloroplast movement, photosystem stoichiometry, stomatal opening and conductance, photosynthetic electron transport, and oxygen evolution (Kim et al. 1993, Nishio 2000, Frechilla et al. 2000, Briggs and Olney 2002, Liscum et al. 2005, Pettai et al. 2005, Loreto et al. 2009).

Interestingly, the importance of green light in photosynthesis is currently being re-examined. Blue and red light are absorbed preferentially at the adaxial side of leaves and are more efficient at driving photosynthesis in this region compared to green light (Sun et al. 1998 Nishio, 2000, Terashima et al. 2009). As a consequence, green light is transmitted deeper into the leaf and is more efficient than either blue or red light at driving CO₂ fixation at the abaxial sides (Sun et al. 1998, Terashima et al. 2009). Less is known on the effect of light quality on photo-protection. Plants exposed to far-red light induce fast, short-term photo-protective mechanism such as state transitions (Wollman 2001, Allen and Forsberg 2001, reviewed in Dietzel et al. 2008). Exposure to far-red light results in a shift to state 1 where PSII absorbs preferentially, while blue light induces a shift to state 2 where PSI absorbs preferentially (Shapiguzov et al. 2010).

To date most photoinhibition and recovery studies are quantified by measuring changes in the pulse amplitude modulated chlorophyll a fluorescence parameter, F_{V}/F_{M}, which is the maximum quantum efficiency of PSII photochemistry. Decreases in F_{V}/F_{M} are correlated to decreases in photosynthesis and this can indicate damage as well as reversible, controlled photo-protective down regulation (Krause et al. 1990, Critchley 1994, Chow et al. 2002). Photochemical quenching of fluorescence (q_{P}) reflects the proportion of open PSII reaction centers and during photoinhibition this is typically decreased due to an abundance of closed centers (Genty et al. 1989, Maxwell and Johnson 2000). It is a measure of imbalances in energy absorbed by PSII relative to PSI and indicates if there is sufficient energy available for photosynthesis (reviewed in Ensminger et al. 2006). Alternatively, 1-q_{P} has been used to indicate the proportion of closed PSII reaction centers and is termed maximum PSII excitation pressure (Ögren and Rosenqvist 1992, Maxwell et al. 1994, Huner et al. 1998).

Non-photochemical quenching (NPQ) of fluorescence is induced to counteract over-excitation and irreversible damage of the photosystems during photoinhibition (Demmig-Adams and Adams 1996, Niyogi 1999, Finazzi et al. 2004, Sun et al. 2006). The dissipation of excess light energy as heat via the xanthophyll cycle is considered to be the most significant component of NPQ (Raven 2011).

Even in light of the above presented prior-art, it would still be desirable to further optimize the recovery from using an artificial illumination system in a photosynthetic environment, specifically in relation to an LED based artificial illumination system, to be able to for example increase the yield and for improving the growth process of a plant.

### SUMMARY OF THE INVENTION

According to a first aspect of the invention, the above is at least partly alleviated by a method for artificial illumination of a plant, the method comprising the steps of controlling an illumination system to illuminate the plant, the emitted light having a first spectral distribution and a first intensity level, the first spectral distribution and the first intensity level selected for optimizing growth of the plant, detecting, using a sensor, the presence of stress in the plant, if stress is detected, controlling the illumination system to illuminate the plant with light having a second spectral distribution and a second intensity level, the second intensity level being lower than the first intensity level.

The invention is based on the understanding that light, temperature, nutrient, water, pests and diseases in some instances introduce stress in the plant. According to the invention, in case stress is automatically determined using a suitable sensor, the spectral distribution as well as the intensity of the light provided for illuminating the plant is adjusted.

Accordingly, advantages with the present invention include the possibility of detecting stress in the plant as well as automatically “treating” such a condition by adjusting the spectral distribution/intensity of light illuminating the plant.

Within the context of the present invention, it should be noted that the expression “illuminating the plant” should be interpreted broadly, including direct and/or indirect (e.g. using adjacent objects such as a wall, roof or floor). Similarly, the expression “optimizing growth of the plant” should be interpreted broadly, that is, it should be understood that the first spectral distribution as well as the first intensity is selected depending for example on the current growth cycle of the plant for the purpose of optimizing one or a plurality of parameters for growing the plant. Such parameters may for example include optimizing the growth of the plant in regards to growing the plant to be high stemmed, wide, etc. In addition, the plant may be optimized in regards to growing the plant for optimizing taste, color, etc. of the plant.

In a preferred embodiment, the second spectral distribution is different from the first spectral distribution. Preferably, the second spectral distribution comprises a combination of 30-50% light from within the blue wavelength region, 30-50% light from within the red wavelength region, and 5-30% light from within the green wavelength region.

It should be noted that the first and the second spectral distribution as well as the first and the second intensity level in any of the above embodiments may be time dependent. That is, it could be possible and is within the scope of the invention (according to any of the above embodiments) to allow illuminate the plant with a “first illumination recipe” (based on the first spectral distribution, the first intensity level and a time constant) for optimizing the growth of the plant, and the using a “second illumination recipe (based on the second spectral distribution, the second intensity level and a time constant) during a recovery phase. As such, the second illumination recipe may be configured to be varying in such a manner that it adjusts itself towards the first illumination recipe once the plant has reached an adequate level of recovery.

It may in some embodiments be advantageous to, using the sensor, also detecting a (normalized) level of stress in the plant. Preferably, the second spectral distribution and the second intensity level may be dependent on the normalized stress level. In an embodiment, in case the sensor detects a stress level lower than a predetermined threshold, the illumination system is controlled to again illuminate the plant with light having the first spectral distribution and the first intensity level, for the purpose of maximizing the growth of the plant.

According to another aspect of the present invention, there is provided an illumination system for artificial illumination of a plant, the illumination system comprising light emitting means configured to emit light of an adjustable spectrum, a sensor configured to detect the presence of stress in the plant, and a control unit, the control unit being electrically coupled to the sensor and the light emitting means, the control unit being configured to control the illumination system to illuminate the plant, the emitted light having a first spectral distribution and a first intensity level, the first spectral distribution and the first intensity level selected for optimizing growth of the plant, detect, using the sensor, a normalized level of stress in the plant, if the normalized stress level is above a predetermined threshold, control the illumination system to illuminate the plant with light having a second spectral distribution and a second intensity level determined by the control unit, the second intensity level being lower than the first intensity level.

Preferably, the light emitting means typically comprise light emitting elements, including for example different types of light emitting diodes (LEDs). As discussed above, using LEDs generally improves the efficiency of the illumination system at the same time as improved heat management is possible. This aspect of the invention provides similar advantages as discussed above in relation to the first aspect of the invention. However, the same or a similar effect may also be provided using one or a plurality of (general) light sources in combination with filters of different colors. Other possibilities are of course possible and within the scope of the invention.

Preferably, the sensor comprises a chlorophyll fluorometer or one or a plurality of photodiodes. The measurement techniques suitable in relation to the invention will be further discussed below in relation to the detailed description of the invention.

According to further aspect of the present invention, there is provided a computer readable medium having stored thereon computer program means for controlling a control unit of an illumination system configured for artificial illumination of a plant, wherein the computer program product comprises code for performing the method steps as discussed above

The control unit is preferably a micro processor or any other type of computing device. Similarly, the computer readable medium may be any type of memory device, including one of a removable nonvolatile random access memory, a hard disk drive, a floppy disk, a CD-ROM, a DVD-ROM, a USB memory, an SD memory card, or a similar computer readable medium known in the art.

Further features of, and advantages with, the present invention will become apparent when studying the appended claims and the following description. The skilled addressee realize that different features of the present invention may be combined to create embodiments other than those described in the following, without departing from the scope of the present invention.

### BRIEF DESCRIPTION OF THE DRAWINGS

The various aspects of the invention, including its particular features and advantages, will be readily understood from the following detailed description and the accompanying drawings, in which:

FIG. 1 shows an illumination system according to a currently preferred embodiment of the invention;

FIG. 2 illustrates the relationship between light provided by an illumination system and its subdivision into different portions when emitted towards a plant;

FIG. 3 illustrates Photoinhibition expressed as decreases in FV/FM for leaves used in the individual LED and dark recovery treatments that are denoted along the x-axis;

FIG. 4 illustrates the effect of photoinhibition on 1-qP (a) and NPQ (b);

FIG. 5 illustrates the effect of photoinhibition on the REP (a), PRI (b), Ch NDI (c) and the NBVI (d);

FIG. 6 illustrates the correlation between the fluorescence parameter FV/FM and the leaf reflectance indices REP (a), PRI (b), Ch NDI (c) and NBVI (d) before and after photoinhibition;

FIG. 7 illustrates spectral irradiance and distribution of the recovery LED light regimes;

FIG. 8 illustrates recovery kinetics of photoinhibited leaves under the various LED light regimes expressed as percent increase in the chlorophyll a fluorescence parameter FV/FM;

FIG. 9 illustrates the correlation between the leaf reflectance indices REP (a), PRI (b), Ch NDI (c) and NBVI (d) and FV/FM during recovery, and

FIG. 10 provides a flow chart of the method steps according to an embodiment of the invention.

### DETAILED DESCRIPTION

The present invention will now be described more fully hereinafter with reference to the accompanying drawings, in which currently preferred embodiments of the invention are shown. This invention may, however, be embodied in many different forms and should not be construed as limited to the embodiments set forth herein; rather, these embodiments are provided for thoroughness and completeness, and fully convey the scope of the invention to the skilled addressee. Like reference characters refer to like elements throughout.

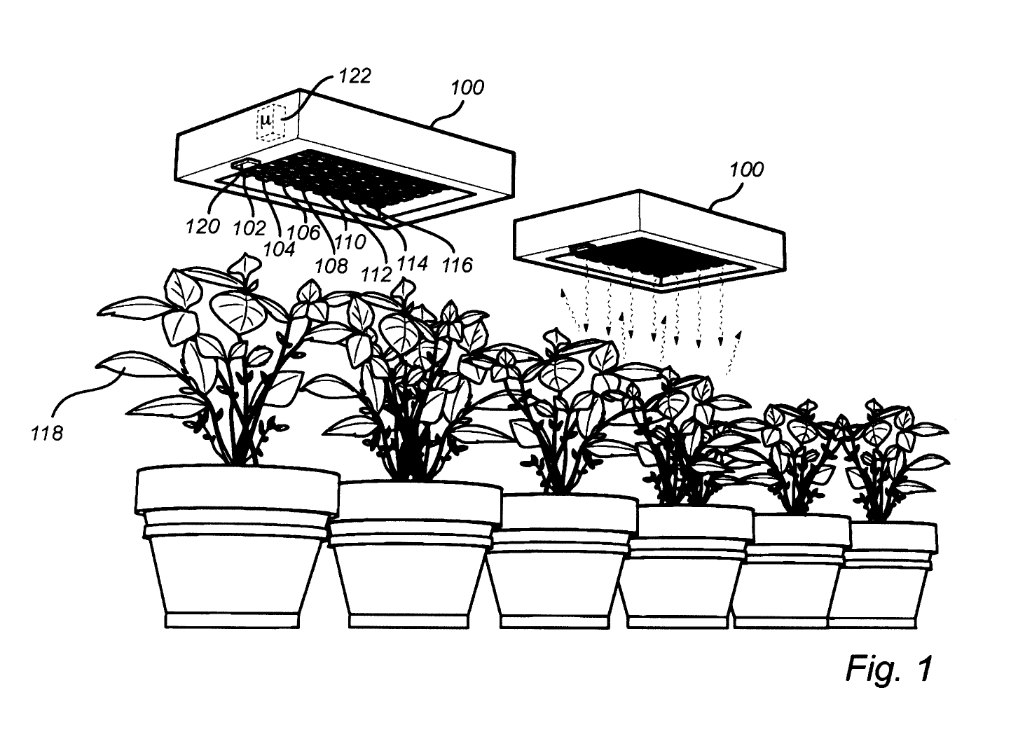

Referring now to the drawings and to FIG. 1 in particular, there is depicted an illumination system 100 according to a possible embodiment of the invention. The illumination system 100 comprises at least one light source. In the illustrated embodiment eight differently colored LED based light sources 102, 104, 106, 108, 110, 112, 114, 116 are provided for illuminating a plant 118. The illumination system 100 further comprises a sensor 120 configured to receive light reflected by the plant and a control unit 122, where the control unit 122 is electrically coupled to the sensor 120 as well as to the light sources 102-116.

Preferably, the light sources have different colors (spectra) and typically overlapping spectral distribution (i.e. wavelength ranges overlapping each other and having different peak wavelengths). The different colors of the light sources 102-116 typically range from ultraviolet to far-red. Even though eight light sources 102-116 are illustrated in FIG. 1, more as well as less light sources may be provided within the scope of the invention. Similarly, more light sources of the same color may be provided to achieve desirable power in a specific wavelength range. The sensor 120 selected for receiving a light based feedback from the plants, including for example a chlorophyll fluorometer or one or a plurality of photodiodes, a CCD sensor. As in regards to the light sources, there may be provided a single or a plurality of sensors 120.

The control unit 122 may be analogue or time discrete, include a general purpose processor, an application specific processor, a circuit containing processing components, a group of distributed processing components, a group of distributed computers configured for processing, etc. The processor may be or include any number of hardware components for conducting data or signal processing or for executing computer code stored in memory. The memory may be one or more devices for storing data and/or computer code for completing or facilitating the various methods described in the present description. The memory may include volatile memory or non-volatile memory. The memory may include database components, object code components, script components, or any other type of information structure for supporting the various activities of the present description. According to an exemplary embodiment, any distributed or local memory device may be utilized with the systems and methods of this description. According to an exemplary embodiment the memory is communicably connected to the processor (e.g., via a circuit or any other wired, wireless, or network connection) and includes computer code for executing one or more processes described herein. A similar functionality as is provided by means of the digital control unit may of course be achieved using analogue and/or a combination of electronic circuitry.

The plant 118 may be any type of plant suitable for growth stimulated by an illumination system 100 configured for providing artificial illumination. The type of plant may include herbs, medicinal plants, ornamental and general crops, etc.

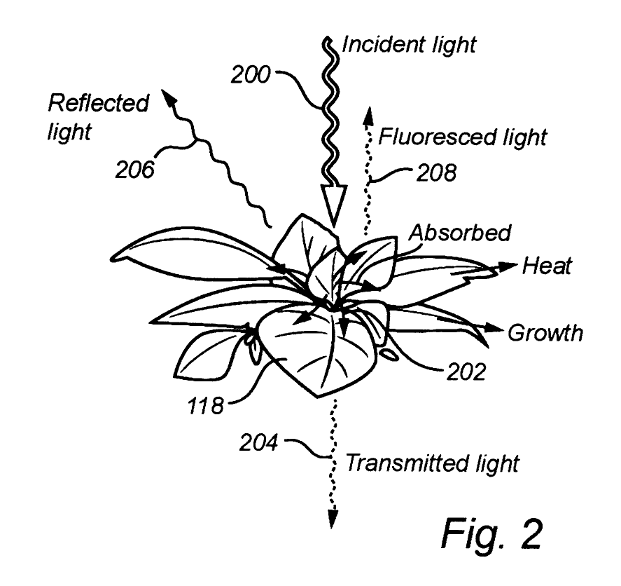

With further reference to FIG. 2, there is provided an illustration of the relationship between light provided by an illumination system and its subdivision into different portions when emitted 200 towards the plant 118. As discussed above, light emitted by the illumination system 100 towards the plant 118 may typically be subdivided into different portions, including at least light being absorbed 202 by the plant 118 for stimulating its growth or performance, light transmitted through 204 the plant 118 down towards the soil, and light reflected 206 by the plant 116. As may be seen from FIG. 2, a further component relating to fluoresced light 208 generated by the plant 118 is additionally provided. The light absorbed 202 by the plant 116 may be further subdivided into stimulation for growth and heating of the plant and its ambience.

In relation to an exemplary experiment performed in relation to the present invention, Ocimum basilicum L. (sweet basil) was grown in standard potting soil under an LED full spectrum lamp in home-made 1.4 m² reflective polystyrene growth units at room temperature (day 23°-25° C./night 20°-24° C.) and an 18 h photoperiod. Growth irradiance at the top of the canopy was maintained at 90 μmol quanta m⁻² s⁻¹. Light irradiance and spectral distributions were measured with a LI-COR quantum sensor. Plants were fertilized at each watering with VITA-GRO™ while keeping a constant N application at 200 ppm.

In relation to the exemplary experiment, blue light is defined as 400-500 nm, green as 500-600 nm, red as 600-700 nm and far-red as 700-800 nm. The LEDs used in the recovery treatments are referred to by their peak maxima: blue (400 nm, 420 nm and 450 nm), green (530 nm), red (630 nm and 660 nm) and far-red (735 nm).

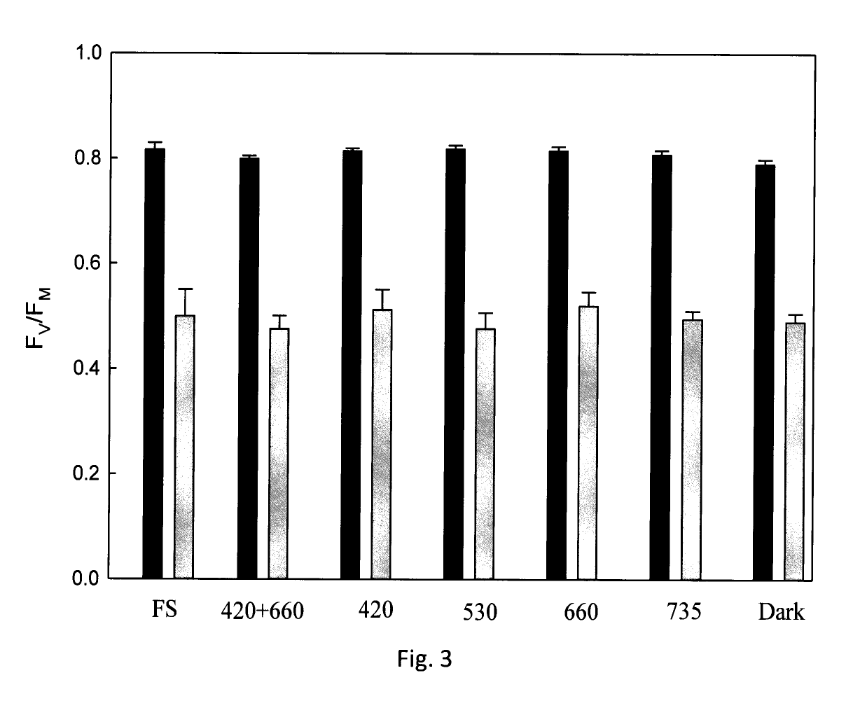

In relation to the exemplary experiment, the uppermost fully expanded leaves (3^{rd} pair) were harvested from plants after 20 days of growth (mid-exponential growth phase) and kept on moist paper towels throughout the treatments. Photoinhibition was induced at 1500-1800 μmol quanta m⁻² s⁻¹ under a HPS lamp (SON-T, Philips, NL) with leaf surface temperatures maintained at between 10° and 12° C. by placing the leaves in aluminum trays that were kept on ice. Photoinhibition treatments were performed until leaves were uniformly photoinhibited (approx. 1 h) as indicated by F_{V}/F_{M} values. Fluorescence induction curves were performed pre-photoinhibition, after photoinhibition and then subsequently at 20, 60 and 120 min into recovery. Photoinhibited leaves were allowed to recover at room temperature in the dark and at low light under individual LED treatments with peak maxima at 420 nm, 530 nm, 660 nm, 735 nm, 420 nm+660 nm and full spectrum as seen in relation to FIGS. 3a-f. Recovery light was between 23-25 μmol quanta m⁻² s⁻¹ under all recovery treatments except under 735 nm and 530 nm where it was 8 and 15 μmol quanta m⁻² s⁻¹ respectively.

Recovery was measured as increases in maximum PSII photochemical efficiency (F_{V}/F_{M}) and pseudo first-order recovery rate constants (k) and maximum recovery (a) were calculated by fitting the data using nonlinear regression (Sigma plot, version 6.0) to y=a+b (1−e^{-kt}) as described in Greer et al. 1988).

In relation to the exemplary experiment, chlorophyll a fluorescence measurements were made with a pulse amplitude modulated chlorophyll fluorometer at room temperature. Prior to all measurements, plants were dark adapted for 20 min to fully oxidize Q_{A}. Minimum fluorescence (Fₒ) was measured using weak far-red light while maximum fluorescence (F_{M}) was measured after a saturating pulse of 10,000 μmol photons/m²/s for 800 ms. The ratio, F_{V}/F_{M} was used to indicate changes in the maximum efficiency of PSII photochemistry with F_{V} calculated as F_{M}−Fₒ (Krause and Weis 1991). Photochemical quenching was determined as (F′_{M}−F)/(F′_{M}−Fₒ) while maximum PSII excitation pressure was calculated as 1-q_{P} (van Kooten and Snel 1990, Huner et al. 1998). Non-photochemical quenching of chlorophyll fluorescence, NPQ, was calculated as (F_{M}/F′_{M})−1 (Bilger and Björkman, 1990).

In relation to the exemplary experiment, plant leaf reflectance parameters were measured on leaves directly after the fluorescence induction curves before and after photoinhibition and during recovery. On-leaf reflectance was measured with a calibrated spectrometer fitted with a bifurcated fiber. Spectral resolution was one sample every 0.4 nm. Illumination for the reflectance measurements was provided by a Mikropack UV-VIS-NIR Lightsource). Three leaf reflectance measurements were made on each leaf at wavelengths ranging from 300 to 900 nm and were calculated by normalizing the radiance of the leaf to that of a reflective surface (Spectralon, Labsphere, Inc., Sutton, N.H., USA). The Photochemical Reflectance Index (PRI) was calculated as (R₅₃₁−R₅₇₀)/(R₅₃₁+R₅₇₀), the Chlorophyll Nominal Difference Index (Chl NDI) as (R₇₅₀−R₇₀₅)/(R₇₅₀+R₇₀₅) and the Narrow Band Vegetation Index (NBVI) as R₇₅₀/R₇₀₀, where R is the reflectance taken from the reflectance curves at the specific wavelengths (subscripts)±1 nm (Gamon et al. 1997; Lichtenthaler et al, 1998; Richardson et al. 2001).

The reflectance values were selected from the spectra as the median of the reflectance within a range of ±1 nm around the specific wavelength. Since this range varies in the literature, a sensitivity analysis was performed to check how sensitive the reflectance parameters were to the range within which the reflectance values were taken from the reflectance curves (ranges of 0-20 nm where checked). The indices that are presented here were not sensitive to this range and hence were selected to work with in this study. The Red Edge Position (REP) is defined as the wavelength of the maximum slope of the reflectance curve within the interval of 680 to 750 nm. The REP was determined as the wavelength for the maximum derivative of a curve fitted to the reflectance data in a least square sense. The curve fitted to the data was the inverted Gaussian curve

$$R ( λ , θ ) = {θ}_{2} - ( {θ}_{2} - {θ}_{1} ) exp ( \frac{{( λ , {θ}_{4} )}^{2}}{2 {θ}_{3}^{2}} )$$

where the wavelength of the maximum derivative is given by λ=θ₃+θ₄ (Bonham-Carter 1988, Dawson and Curran 1997). The curve fitting was done in MATLAB with the function “lsqcurvefit”.

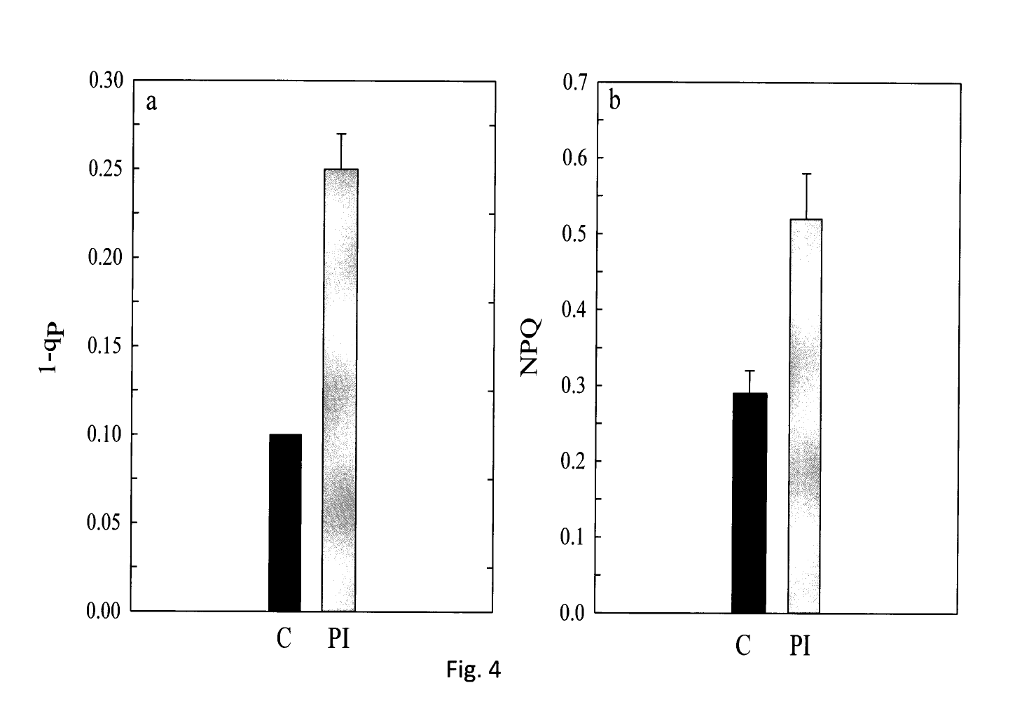

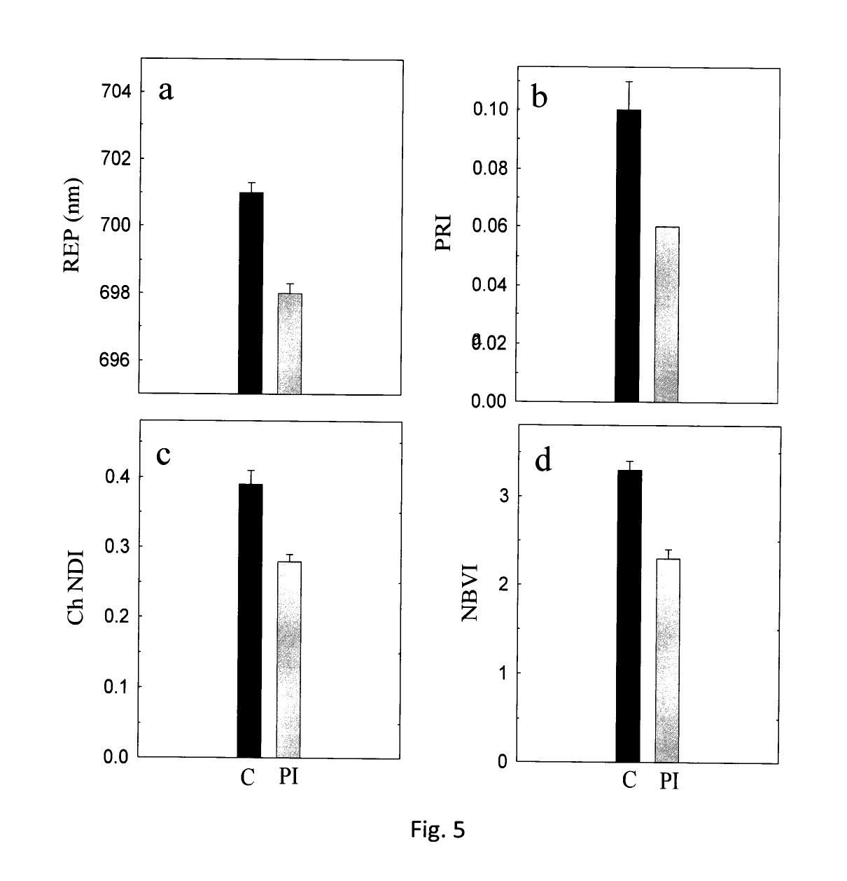

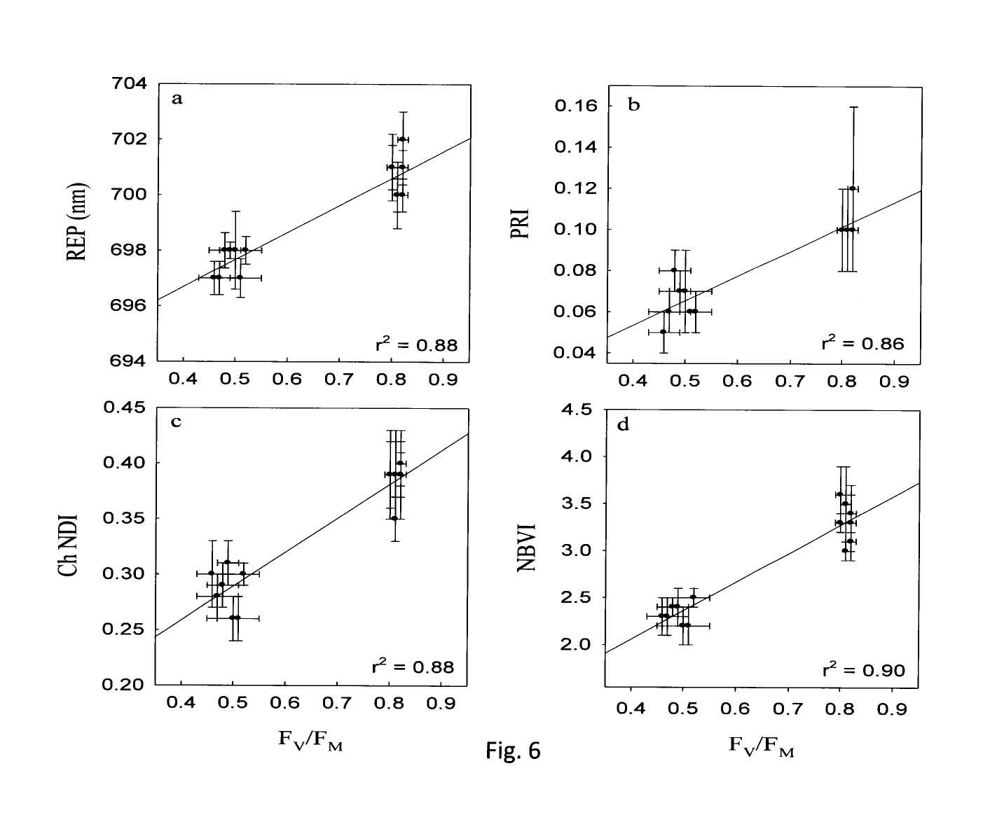

In relation to the exemplary experiment, detached leaves were exposed to the photoinhibitory conditions of high light (HPS at 1500-1800 μmol) and low temperature (10°-12° C.) prior to the recovery treatments. All samples were photoinhibited to the same extent as indicated by similar decreases of between 37% and 42% in maximum PSII photochemical efficiency (F_{V}/F_{M}) (FIG. 1). In addition, photoinhibition resulted in a 1.6-fold increase in PSII excitation pressure (1-q_{P}) and a 1.8-fold increase in non-photochemical quenching (NPQ) as seen in relation to FIG. 4 a-d. Reflectance spectra were generated for each leaf directly after the fluorescence measurements. Photoinhibition resulted in an overall shift in the REP, from 701 nm±0.3 to 698 nm±0.3 as seen in FIG. 5a. The photochemical reflectance index (PRI) decreased by 40%, the chlorophyll nominal difference index (Ch NDI) decreased by 28% and the narrow band vegetative index (NBVI) by 30% after photoinhibition as seen in FIGS. 4 b-d. As seen in FIG. 5b, a strong correlations (r²=0.86−0.90) between the spectral reflectance parameters and F_{V}/F_{M} were observed and suggest that the REP, PRI, Chl NDI, NBVI all have the potential to detect photoinhibition, as shown in FIG. 6.

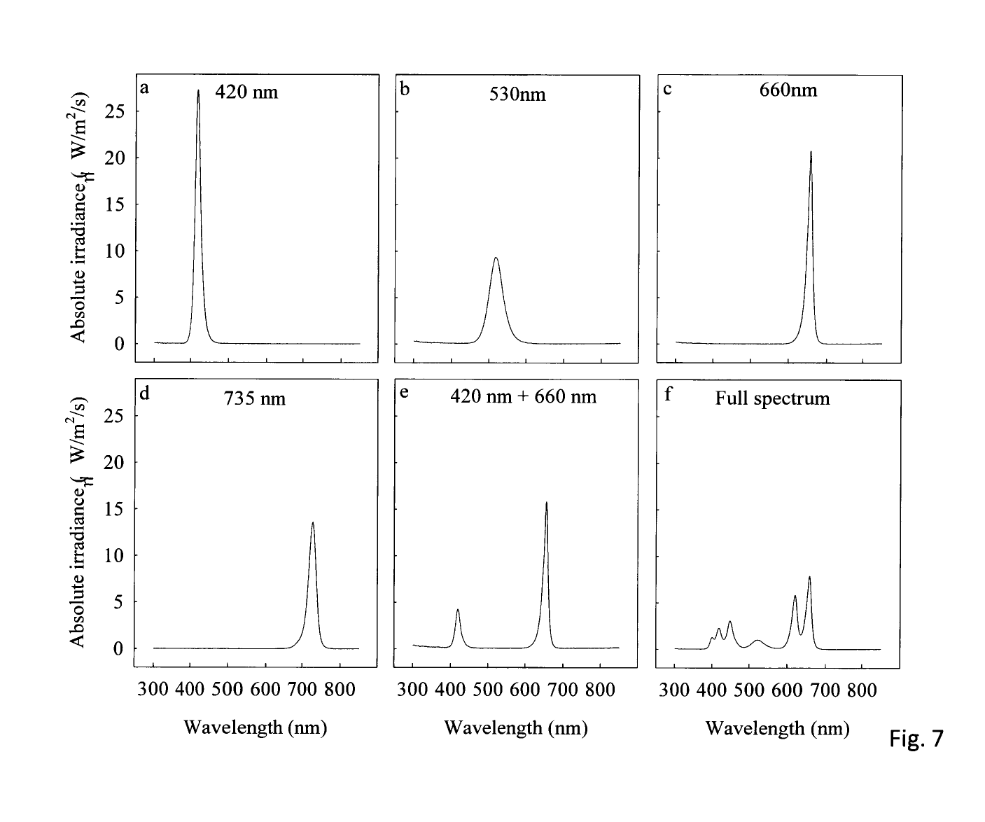

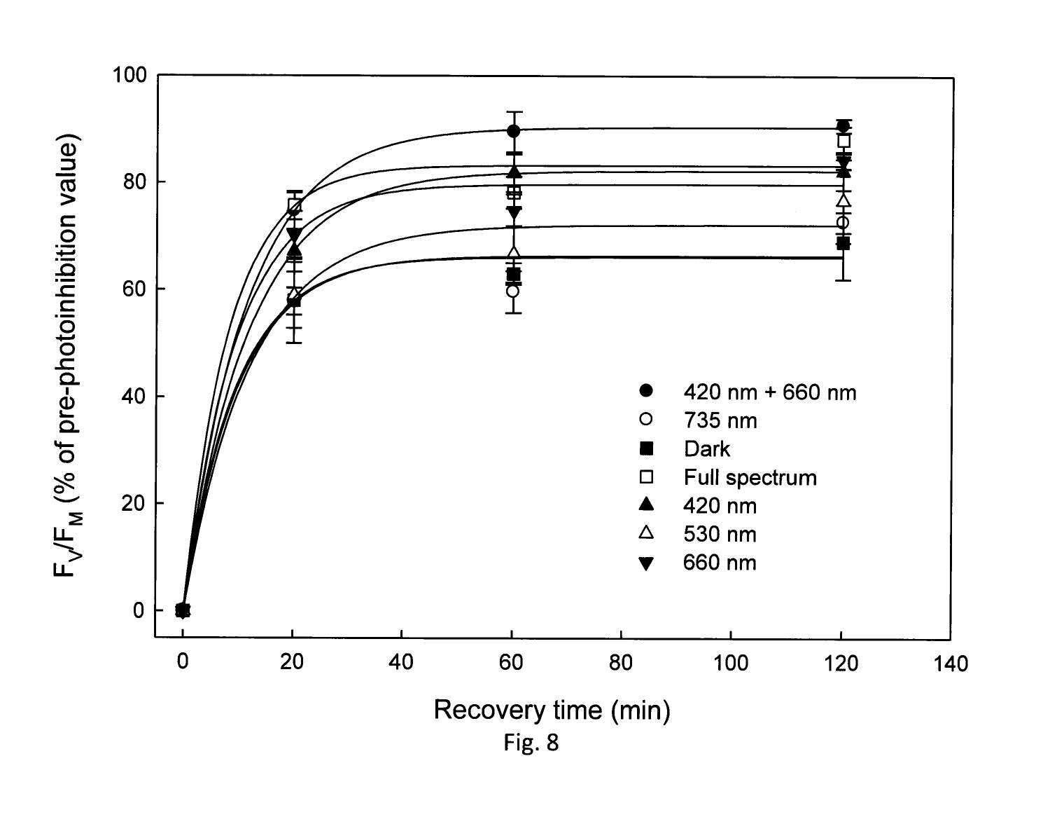

In relation to the exemplary experiment, photoinhibited leaves were recovered at room temperature under the individual light quality treatments depicted in FIG. 7a-f. The recovery from photoinhibition was measured as the increase in F_{V}/F_{M} at 20 min, 60 min and 120 min during the recovery treatments as shown in FIG. 8. The interpolated rate constants for recovery (k) divided the different recovery treatments into two distinct groups. Under full spectrum (FS), 660 nm and the combination of 420 nm+660 nm the k values were the highest at 0.12 and 0.13 (Table 1). The second grouping had values for k that were 38% less (0.07 and 0.08) and were observed under the recovery treatments of 530 nm, 420 nm, 735 nm and in the dark (Table 1). Maximum recovery (a) was highest after recovery under FS and 420 nm+660 nm treatments with 88-89% recovery.

TABLE 1
Rate constants (k) and the maximum capacity for recovery (a) for the
recovery of the fluorescence parameter F_{V}/F_{M} under different
mixed and individual LED groups ranging from blue (420 nm), green
(530 nm), red (660 nm) and far-red (735 nm). The rate constants and the
maximum capacity for recovery were determined from the recovery
kinetics depicted in FIG. 6 which were fitted to the equation y = a + b
(1 − e^{-kt}).
Values represent means ± standard error, n = 3-9.

| | | Recovery treatment | | |
|---|---|---|---|---|
| | | k | a | r² |
| Full spectrum | | 0.12 ± 0.02 | 89 ± 3 | 0.99 ± 0.01 |
| 420 + 660 | nm | 0.13 ± 0.01 | 88 ± 2 | 0.99 ± 0.00 |
| 660 | nm | 0.13 ± 0.03 | 80 ± 1 | 0.98 ± 0.01 |
| 420 | nm | 0.08 ± 0.01 | 82 ± 2 | 0.99 ± 0.01 |
| 530 | nm | 0.08 ± 0.01 | 76 ± 7 | 0.97 ± 0.02 |
| 735 | nm | 0.07 ± 0.01 | 64 ± 1 | 0.98 ± 0.01 |

| | | | |
|---|---|---|---|
| Dark | 0.08 ± 0.02 | 70 ± 8 | 0.93 ± 0.03 |

In relation to the exemplary experiment, this was followed by 420 nm (82%), 660 nm (80%), 530 nm (76%), dark (70%) and finally by 735 nm (64%) (Table 1). The recovery of 1-qₚ under individual spectral qualities followed a similar trend as that for F_{V}/F_{M}. The FS and the combination of 420 nm+660 nm recovery treatments resulted in the recovery of 1-qₚ down to the pre-photoinhibitory values of 0.10 and 0.09, respectively (Table 2). Recovery of 1-qₚ was observed, albeit to a lesser extent, in leaves recovered under all of the other light quality treatments with 88% recovery under 530 nm, 76% under 420, 71% under 660 nm, 50% and 43% in the dark and 735 nm, respectively (Table 2). In contrast, the recovery in NPQ was not apparent in all of the recovery treatments. Recovery of NPQ occurred in leaves recovered under 420 nm+660 nm and FS where recovery was close to the pre-photoinhibited values of 0.28 (Table 2). Leaves under 660 nm, 735 nm and 420 nm recovered NPQ by 41%, 46% and 54%, respectively, whereas little recovery was observed under 530 nm and dark recovery treatments (9%).

TABLE 2
The recovery of PSII excitation pressure (1 − qP) and non-photochemical
quenching (NPQ) under different mixed and individual LED groups
ranging from blue (420 nm), green (530 nm), red (660 nm) to far-red
(735 nm) and in the dark. Measurements were taken when the leaves
had recovered for 20 min, 1 h and 2 h. Values represent means ±
standard errors, n = 3-9. Pre-photoinhibitory values for
1 − qP nd NPQ were 1.0 and 0.28, respectively.

| Treatment | | 0 | 20 | 60 | 120 |
|---|---|---|---|---|---|
| | | 1 − qₚ | | | |
| | | Recovery time (min) | | | |
| 420 + 660 | nm | 0.25 ± 0.02 | 0.14 ± 0.02 | 0.10 ± 0.03 | 0.09 ± 0.02 |
| FS | | 0.26 ± 0.04 | 0.18 ± 0.02 | 0.13 ± 0.02 | 0.10 ± 0.02 |
| 530 | nm | 0.26 ± 0.08 | 0.18 ± 0.04 | 0.14 ± 0.01 | 0.12 ± 0.01 |
| 420 | nm | 0.27 ± 0.06 | 0.21 ± 0.03 | 0.15 ± 0.03 | 0.14 ± 0.01 |
| 660 | nm | 0.24 ± 0.05 | 0.18 ± 0.01 | 0.18 ± 0.05 | 0.14 ± 0.01 |
| 735 | nm | 0.24 ± 0.03 | 0.20 ± 0.04 | 0.17 ± 0.03 | 0.18 ± 0.03 |
| Dark | | 0.26 ± 0.03 | 0.20 ± 0.07 | 0.17 ± 0.03 | 0.18 ± 0.06 |
| | | NPQ | | | |
| | | Recovery time (min) | | | |
| 420 + 660 | nm | 0.53 ± 0.04 | 0.52 ± 0.03 | 0.43 ± 0.06 | 0.31 ± 0.03 |
| FS | | 0.53 ± 0.06 | 0.33 ± 0.04 | 0.34 ± 0.03 | 0.34 ± 0.04 |
| 420 | nm | 0.52 ± 0.02 | 0.42 ± 0.03 | 0.41 ± 0.02 | 0.39 ± 0.02 |
| 735 | nm | 0.52 ± 0.06 | 0.45 ± 0.07 | 0.40 ± 0.06 | 0.41 ± 0.04 |
| 660 | nm | 0.55 ± 0.07 | 0.47 ± 0.07 | 0.49 ± 0.03 | 0.44 ± 0.08 |
| Dark | | 0.50 ± 0.02 | 0.50 ± 0.07 | 0.50 ± 0.04 | 0.48 ± 0.05 |
| 530 | nm | 0.51 ± 0.07 | 0.47 ± 0.05 | 0.49 ± 0.08 | 0.49 ± 0.08 |

Thus, a sustained xanthophyll cycle was observed in leaves recovered under 530 nm and in the dark.

In relation to the exemplary experiment, the REP in leaves recovered up to pre-photoinhibition values of 700-702 nm under FS, 420 nm+660 nm, 530 nm and the dark treatments while there was little recovery under 420 nm, 630 nm and 735 nm recovery treatments.

TABLE 3
The recovery of the on-leaf reflectance indices REP (a), PRI (b), Ch NDI
(c) and NBVI (d) under different mixed and individual LED groups
ranging from blue (420 nm), green (530 nm), red (660 nm) to far-red
(735 nm) and the dark. Measurements were taken when the leaves had
recovered for 20 min, 1 h and 2 h. Values represent means ± standard
errors, n = 3-9. Pre-photoinhibitory values for the REP, PRI,
Chl NDI and NBVI were 701 nm, 0.10, 0.38 and 3.2, respectively.

| Treatment | | 0 | 20 | 60 | 120 |
|---|---|---|---|---|---|
| | | REP | | | |
| | | Recovery time (min) | | | |
| FS | | 697 ± 0.6 | 699 ± 0.5 | 699 ± 0.8 | 701 ± 0.8 |
| 420 + 660 | nm | 697 ± 0.7 | 699 ± 0.5 | 699 ± 0.7 | 700 ± 0.9 |
| Dark | | 698 ± 0.3 | 700 ± 0.6 | 701 ± 1.2 | 700 ± 1.0 |
| 530 | nm | 698 ± 1.4 | 700 ± 1.3 | 700 ± 1.8 | 700 ± 1.1 |
| 420 | nm | 698 ± 0.6 | 699 ± 0.5 | 699 ± 0.5 | 699 ± 1.4 |
| 660 | nm | 698 ± 0.5 | 699 ± 0.4 | 699 ± 0.9 | 699 ± 0.7 |
| 735 | nm | 697 ± 0.6 | 699 ± 0.7 | 699 ± 0.8 | 699 ± 0.7 |
| | | PRI | | | |
| | | Recovery time (min) | | | |
| FS | | 0.06 ± 0.01 | 0.07 ± 0.01 | 0.06 ± 0.01 | 0.08 ± 0.01 |
| 420 + 660 | nm | 0.06 ± 0.00 | 0.06 ± 0.01 | 0.07 ± 0.01 | 0.07 ± 0.00 |
| 530 | nm | 0.07 ± 0.02 | 0.07 ± 0.02 | — | 0.06 ± 0.02 |
| 420 | nm | 0.08 ± 0.01 | 0.05 ± 0.01 | 0.06 ± 0.02 | 0.05 ± 0.01 |
| 735 | nm | 0.05 ± 0.01 | 0.05 ± 0.01 | 0.06 ± 0.01 | 0.05 ± 0.01 |
| 660 | nm | 0.06 ± 0.01 | 0.05 ± 0.01 | 0.05 ± 0.01 | 0.04 ± 0.01 |
| Dark | | 0.07 ± 0.01 | 0.07 ± 0.01 | 0.06 ± 0.02 | 0.03 |
| | | Chl NDI | | | |
| | | Recovery time (min) | | | |
| Dark | | 0.31 ± 0.02 | 0.32 ± 0.01 | 0.29 ± 0.04 | 0.34 ± 0.03 |
| FS | | 0.28 ± 0.02 | 0.31 ± 0.02 | 0.31 ± 0.02 | 0.30 ± 0.02 |
| 420 + 660 | nm | 0.26 ± 0.02 | 0.32 ± 0.02 | 0.31 ± 0.02 | 0.30 ± 0.02 |
| 660 | nm | 0.30 ± 0.01 | 0.32 ± 0.01 | 0.30 ± 0.02 | 0.30 ± 0.01 |
| 530 | nm | 0.26 ± 0.02 | 0.29 ± 0.01 | 0.27 ± 0.02 | 0.27 ± 0.02 |
| 735 | nm | 0.30 ± 0.03 | 0.29 ± 0.02 | 0.27 ± 0.02 | 0.27 ± 0.01 |
| 420 | nm | 0.29 ± 0.02 | 0.31 ± 0.02 | 0.33 ± 0.02 | 0.29 ± 0.05 |
| | | NBVI | | | |
| | | Recovery time (min) | | | |
| FS | | 2.3 ± 0.2 | 2.7 ± 0.1 | 2.4 ± 0.2 | 3.1 ± 0.3 |
| Dark | | 2.4 ± 0.2 | 2.7 ± 0.1 | 3.1 ± 0.3 | 2.9 ± 0.2 |
| 420 + 660 | nm | 2.2 ± 0.2 | 2.8 ± 0.3 | 2.7 ± 0.2 | 2.8 ± 0.2 |
| 660 | nm | 2.5 ± 0.1 | 2.5 ± 0.2 | 2.9 ± 0.2 | 2.4 ± 0.1 |
| 530 | nm | 2.2 ± 0.2 | 2.5 ± 0.1 | 2.1 ± 0.1 | 2.2 ± 0.1 |
| 735 | nm | 2.3 ± 0.2 | 2.5 ± 0.1 | 2.3 ± 0.1 | 2.1 ± 0.1 |
| 420 | nm | 2.4 ± 0.1 | 2.5 ± 0.1 | 2.4 ± 0.1 | 2.1 ± 0.2 |

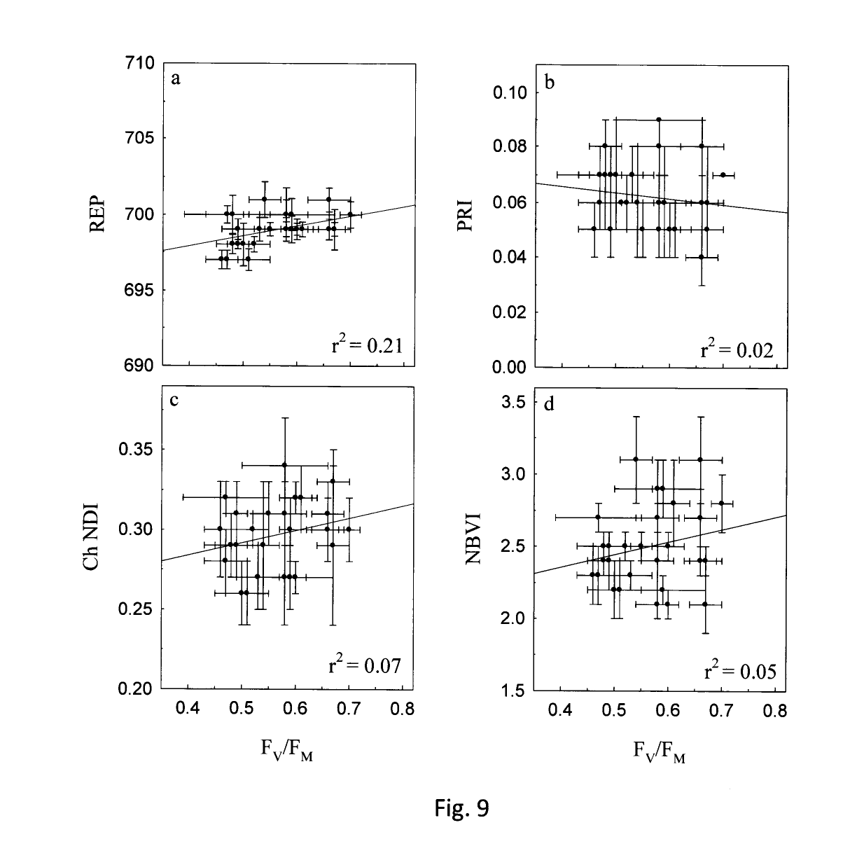

The recovery of PRI never reached the pre-photoinhibition values of 1.0. However, PRI for leaves recovered under FS and 420 nm+660 nm recovered to 0.08 and 0.07, respectively while under the other treatments the PRI remained the same or continued to drop. Recovery of the Chl NDI close to the pre-photoinhibition value of 0.39 was only apparent in leaves recovered under the dark treatment (0.34) while in all other treatments little or no recovery of the Ch NDI occurred. The average pre-photoinhibition NBVI value was 3.3 and leaves recovered under FS recovered closest to this value (3.1) and was followed by the dark (2.9) and 420 nm+660 nm (2.8) treatments. There was no apparent recovery in the NBVI for all other recovery treatments. In contrast to the strong correlations between leaf reflectance parameters and photoinhibition (F_{V}/F_{M}), see FIGS. 8a-d, there was very little correlation (r²=0.02-0.21) was observed between the leaf reflectance parameters and the recovery of F_{V}/F_{M}, see FIG. 9 a-d.

In relation to the present invention, it has been found that wider spectra (ie. more than one LED group) are necessary for optimal rates and extents of recovery (Table 1). A faster rate and fullest extent of recovery of F_{V}/F_{M} were observed in leaves recovered under the full spectra growth spectrum (FS) and the combination of blue (420 nm) and red (660 nm) light compared to recovery under single LED groups. Photochemical quenching (qₚ) and non-photochemical quenching (NPQ) minimize the production of singlet oxygen under stress conditions which is extremely damaging to the photosynthetic apparatus (Müller et al. 2001).

Recovery under FS and 420 nm+660 nm resulted in the fastest recovery of F_{V}/F_{M}, and this could be due to the relaxation of 1-qₚ and, in the case of FS the reversal of NPQ (Tables 1,2). Recovery under 420 nm+660 nm NPQ resulted in a sustained NPQ for the first hour therefore the opening of PSII reaction centers (1-qₚ) was sufficient for the fast recovery of photosynthesis (Tables 1,2). NPQ consists of three components, the first and primary component, qE, is the fastest and is the pH- or energy-dependent component; the second, qT, involves state transitions and is considered to play only a minor role in plants compared to algae; the third, qI, is slowly reversible and is not fully understood but it is thought that it is a mix of photo-protection and photo-damage (Müller et al. 2001).

From this it may be suggested that FS is sufficient to relax NPQ by preventing the over-reduction of the electron transport chain and over-acidification of the lumen whereas recovery under 420 nm+660 nm is more complex and although there is recovery of photochemistry there is still some photo-damage occurring.

The recovery of chlorophyll fluorescence parameters were ranked for each recovery treatment.

TABLE 4
The ranking of the various LED and dark recovery treatments
in descending order.
Rate constant for the recovery of F_{V}/F_{M}, k; the maximum capacity
for the recovery of F_{V}/F_{M}, a; the recovery of maximum PSII
photochemical efficiency, F_{V}/F_{M}; PSII excitation pressure,
1 − q_{P}; and non-photochemical quenching, NPQ.

| Ranking | k | a | F_{V}/F_{M} | 1 − qₚ | NPQ |
|---|---|---|---|---|---|
| 1 | FS | FS | FS | B + R | B + R |
| 2 | B + R | B + R | B + R | FS | FS |
| 3 | 660 nm | 420 nm | 420 nm | 530 nm | 420 nm |
| 4 | 420 nm | 660 nm | 660 nm | 420 nm | 735 nm |
| 5 | 530 nm | 530 nm | 530 nm | 660 nm | 660 nm |
| 6 | 735 nm | Dark | Dark | 735 nm | Dark |
| 7 | Dark | 735 nm | 735 nm | Dark | 530 nm |

It is accepted that photosynthesis under low intensity ‘white’ light is required for recovery when compared to recovery under dark conditions (Yokthongwattana and Melis 2005, Mohanty et al. 2007, Raven 2011).

Thus, it is not surprising that the lowest rate and extent of recovery was in leaves recovering in the dark where photosynthesis cannot operate. However, it was surprising that recovery from photoinhibition under far-red light was non-existent. Recovery of F_{V}/F_{M} under far-red light ranked second last and last in the rate and extent of recovery, respectively and was similar to recovery under the dark (Table 4). Plants have evolved and adapted to far-red rich environments such as within and under canopies and have both the capacity for photosynthesis and photo-protection in this environment (Aphalo et al. 1999). Far-red light up to 800 nm was able to drive PSII photochemistry at both the donor and acceptor sides and it was proposed that an alternative charge separation pathway for far-red excitation exists (Thapper et al. 2009).

With respect to photoprotection, it is well known that energy imbalances in the electron transport chain can be alleviated under far-red light through either short- and longer-term protective mechanisms, state transitions or alterations in photosystem stoichiometry, respectively (Kim et al. 1993, Anderson et al. 1995, Melis et al. 1996, Wollman 2001, Allen and Forsberg 2001, Shapiguzov et al. 2010). Even though NPQ was able to relax and PRI photochemistry was able to moderately recover (1-qₚ) under far-red light, the leaves were not able to recover the rate or extent of PSII photochemical efficiency (F_{V}/F_{M}). A topic for further investigation is to determine if the low F_{V}/F_{M} values observed during the recovery under far-red light were due to damage or a controlled and maintained down-regulation of PSII.

The recovery from photoinhibition was also examined under individual light qualities that are not typically found in terrestrial habitats in order to further understand the contribution of each LED group to recovery. The extent of the recovery of F_{V}/F_{M} under individual red (660 nm) and individual blue (420 nm) light qualities were similar and ranked 3^{rd} and 4^{th}, just below FS and 420+660 nm (Table 4). Therefore, it appears that red light or blue light alone was not sufficient to induce or maintain processes of repair necessary for the full extent of recovery. The lack of full recovery under 420 nm light could be due to the adverse effects on plants by blue light. For instance, photoinhibition occurs under low blue light through the inactivation of PSII due to the absorption by the manganese in the oxygen evolving complex (Hakala et al. 2005, Takahashi and Murata 2008). Blue light also causes a decrease in photosynthesis through either inefficient energy transfer by blue light absorbing carotenoids to the chlorophylls and blue-light induced decreases in photochemical efficiency (Loreto et al. 2009). Less is known about red light on photosynthesis or photo-protection.

Growth under red light alone (660 nm) has resulted in less dry weight accumulation in radish, spinach and lettuce however only in radish the photosynthetic rates were lower, indicating a potential species specific photosynthetic response to light quality (Yorio et al. 2001). Hogewoning et al. (2010) observed that cucumbers grown under red light had low photosynthetic capacity (A_{Max}) compared to cool white fluorescent lamps and blue (450 nm) and red (638 nm) LEDs mixed together. They found that 30% blue light mixed with red was necessary for optimal photosynthesis.

Furthermore, chlorophyll fluorescence imaging revealed that, in contrast to blue light, growth under red light resulted in the heterogeneous distribution of F_{V}/F_{M} with values of approximately 0.8 in tissues next to the veins and 0.55-0.70 between the veins (Hogewoning et al., 2010). Two observations come to light here: 1) these findings show the importance and necessity of assessing photochemistry over the entire leaf or consistently at the same place on leaves and 2) the peak maxima of the LEDs and the use of filters with various light sources in light quality experiments need to be defined and interpreted carefully. The red LED used in the latter experiments had peak maxima of 638 nm that is close to one of the peaks in the action spectrum for photo-damage (Takahashi et al. 2010). Contrary to popular belief, green light does participate in photosynthesis (McCree 1972, Sun et al. 1998, Nishio 2000, Terashima et al. 2009). Recovery under green light ranked 5^{th} with respect to the rate and extent of the recovery of F_{V}/F_{M} (Table 4). Similarly to recovery in the dark, NPQ was sustained throughout the recovery period which indicates a sustained xanthophyll cycle under these recovery conditions (Table 2).

Therefore, the lack of recovery of F_{V}/F_{M} in green light could be due to an active xanthophyll cycle that prevents light from reaching the photosystems, especially in the abaxial sides of the leaves (Demmig-Adams and Adams 1996, Terashima et al. 2009). What was interesting during recovery under green light was that it ranked 3^{rd} in its ability to re-enable electron transport as observed by the relaxation of 1-qp (Table 2). This last result could be due to green light driving photosynthesis in the deeper layers of the leaves (Vogelman and Han 2000).

The use of plant leaf reflectance as a tool to diagnose stress is increasing due to the availability and affordability of spectrometers and the interest in remote sensing to examine climate change, global terrestrial and aquatic vegetation patterns and plant stress (Geider et al. 2001, Carter and Knapp 2001). There is some evidence supporting the use of plant leaf reflectance as a substitute for chlorophyll fluorescence to detect stress in plants (Penuelas and Filella 1998, Lichtenthaler et al. 1998). However, recent studies have shown that there is a lack of consistency when relating leaf reflectance to plant stress and this is most likely due to interference by other pigments, lack of standardized methods between laboratories and, for remote sensing, variation between types and characteristics of vegetation and soil (Grace et al. 2007). The leaf reflectance parameters that correlated with photoinhibition were the REP, PRI, NBVI and the Chl NDI (FIG. 5). These four specific leaf reflectance indices were good indicators of high light and low temperature stress. Indeed, It has been reported that stress-induced decreases of chlorophyll content is reflected by changes in the REP and this is not species- or pigment-dependent (Carter and Knapp 2001, Richardson et al. 2001, Sims and Gamon 2002, Ciganda et al. 2009). The emission of chlorophyll fluorescence occurs in the red and far-red part of the spectrum and it has been found that shifts in the REP are partially due to the quenching of chlorophyll fluorescence through the xanthophyll cycle (Gamon et al. 1990). The REP, PRI, NBVI and Ch NDI were monitored during recovery and, in contrast to photoinhibition, the only leaf reflectance parameter that correlated, albeit weakly, with the recovery of photoinhibition was the REP as seen in FIG. 9.

In relation to the exemplary experiment, no correlation was found between PRI, Ch NDI or the NBVI with the recovery of photosynthesis (F_{V}/F_{M}) or with relaxation of the reduction state of the electron transport chain (1-qₚ) or NPQ. This is similar to the findings of Busch et al. (2009) where PRI was only moderately correlated with the de-epoxidation state of the xanthophyll cycle and was not correlated with the effective quantum yield of PSII photochemistry (Φ_{PSII}) or NPQ. They suggest that PRI is not a good indicator of NPQ as not all non-photochemical quenching is zeaxanthin dependent. In conclusion, the use of on-leaf reflectance parameters correlated well with photoinhibition but not with recovery (FIGS. 5,7).

According to the invention, it may be established that that ‘mixed’ spectra are required for the optimal recovery of F_{V}/F_{M} in basil. A full spectrum or the minimum mixture of blue and red light were required possibly due to their ability to drive photosynthesis sufficiently to meet the energy demands of repair mechanisms and the prevention of damaging singlet oxygen. Recovery under individual LED groups was observed to a lesser extent than ‘mixed’ light with 660 nm and 420 nm ranking higher than 530 nm, 735 nm or dark recovery treatments (Table 4). Schreiber et al. (2012) have recently shown that measuring and actinic light spectra have an effect on fluorescence measurements in cyanobacteria and green algae (Schreiber et al. 2012). Coupled with the action spectra for photosystem II damage and photoinhibition (Takahashi et al. 2010, Sarvikas et al., 2006), the exemplary experiment point to that spectral quality is important to take into closer consideration during physiological growth conditions and measurements.

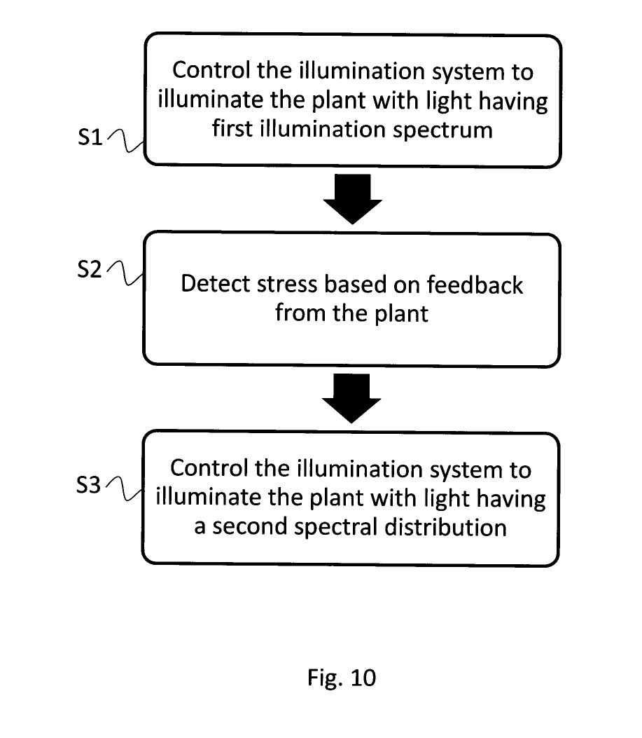

During operation of the illumination system 100, with further reference to FIG. 10 the light sources 102-116 of the illumination system 100 are controlled by the control unit 122, to control, S1, the illumination system 100 to illuminate the plant 118, the emitted light having a first spectral distribution and a first intensity level, the first spectral distribution and the first intensity level selected for optimizing growth of the plant as is further discussed above. Subsequently, the sensor 120 receives a feedback from the plant 116 and detects, S2, in conjunction with the control unit 120. In case stress is detected, for example induced by one of light, temperature, nutrient, drought, pests and diseases, the control unit is in turn configured to control, S3, the illumination system 100 to illuminate the plant 118 with light having a second spectral distribution and a second intensity level, the second intensity level being lower than the first intensity level.

As discussed above, this allows for an automation of stress reduction and/or recovery by adapting the light spectra as well as the intensity level used for illuminating the plant.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. When information is transferred or provided over a network or another communications connection (either hardwired, wireless, or a combination of hardwired or wireless) to a machine, the machine properly views the connection as a machine-readable medium. Thus, any such connection is properly termed a machine-readable medium. Combinations of the above are also included within the scope of machine-readable media. Machine-executable instructions include, for example, instructions and data which cause a general purpose computer, special purpose computer, or special purpose processing machines to perform a certain function or group of functions.

Although the figures may show a specific order of method steps, the order of the steps may differ from what is depicted. Also two or more steps may be performed concurrently or with partial concurrence. Such variation will depend on the software and hardware systems chosen and on designer choice. All such variations are within the scope of the disclosure. Likewise, software implementations could be accomplished with standard programming techniques with rule based logic and other logic to accomplish the various connection steps, processing steps, comparison steps and decision steps. Additionally, even though the invention has been described with reference to specific exemplifying embodiments thereof, many different alterations, modifications and the like will become apparent for those skilled in the art. Variations to the disclosed embodiments can be understood and effected by the skilled addressee in practicing the claimed invention, from a study of the drawings, the disclosure, and the appended claims. Furthermore, in the claims, the word “comprising” does not exclude other elements or steps, and the indefinite article “a” or “an” does not exclude a plurality.

1. A method for artificial illumination of a plant, the method comprising:
controlling an illumination system to illuminate the plant with emitted light, the emitted light having a first spectral distribution and a first intensity level, the first spectral distribution and the first intensity level selected for optimizing growth of the plant;
detecting, using a sensor, a presence of stress in the plant;
when stress is detected, controlling the illumination system to illuminate the plant with light having a second spectral distribution and a second intensity level, the second intensity level being lower than the first intensity level.

2. The method according to claim 1, wherein
the second spectral distribution is different from the first spectral distribution.

3. The method according to claim 2, wherein the second spectral distribution comprises a combination of 30-50% light from within a blue wavelength region, 30-50% light from within a red wavelength region, and 5-30% light from within a green wavelength region.

4. The method according to claim 1, wherein detecting stress, using the sensor, comprises detecting a normalized level of stress in the plant.

5. The method according to claim 5, wherein the second spectral distribution and the second intensity level is dependent on the normalized stress level.

6. The method according to claim 4, wherein the illumination system is controlled to again illuminate the plant with light having the first spectral distribution and the first intensity level when it is determined that a stress level is below a predetermined threshold.

7. An illumination system for artificial illumination of a plant, the illumination system comprising:
a light emitting device configured to emit light of an adjustable spectrum;
a sensor configured to detect a presence of stress in the plant, and
a control unit, the control unit being electrically coupled to the sensor and the light emitting device, the control unit being configured to:
control the illumination system to illuminate the plant with emitted light, the emitted light having a first spectral distribution and a first intensity level, the first spectral distribution and the first intensity level selected for optimizing growth of the plant;
detect, using the sensor, a normalized level of stress in the plant; and
when the normalized stress level is above a predetermined threshold, control the illumination system to illuminate the plant with light having a second spectral distribution and a second intensity level determined by the control unit, the second intensity level being lower than the first intensity level.

8. The illumination system according to claim 7, wherein the control unit adjusts the second spectral distribution and the second intensity level based on the normalized stress level.

9. The illumination system according to claim 7, wherein the sensor comprises one of a chlorophyll fluorometer and one or a plurality of photodiodes.

10. A computer program product comprising a non-transitory computer readable medium having stored thereon computer program means for controlling a control unit of an illumination system configured for artificial illumination of a plant, wherein the computer program product comprises code for performing the method according to claim 1.
